(19) United States
(12) Patent Application Publication
(10) Pub. No.: US 2002/0018689 A1
(43) Pub. Date: Feb. 14, 2002

(54) Adhesive applicators with improved polymerization initiators

(76) Inventors: Ibraheem T. Badejo, Morrisville, NC (US); Jeffrey G. Clark, Raleigh, NC (US); William Cotter, Raleigh, NC (US); William L. Heard, Releigh, NC (US); Daniel L. Hedgpeth, Raleigh, NC (US); Roy F. Thompson JR., Raleigh, NC (US)

Correspondence Address: OLIFF & BERRIDGE, PLC, P.O. Box 19928, Alexandria, VA, 22320, US

(21) Appl. No.: 09/834,615

(22) Filed: Apr. 16, 2001

Related U.S. Application Data
(63) Continuation-in-part of application No. 09/409,672, filed on Sep. 30, 1999.
Application No. 09/409,672 is a division of application No. 09/221,997, filed on Dec. 29, 1998, now Pat. No. 6,099,807.
Application No. 09/221,997 is a division of application No. 08/488,411, filed on Jun. 7, 1995, now Pat. No. 5,928,611.
Application No. 09/221,997 is a division of application No. 08/909,845, filed on Aug. 12, 1997, now abandoned.
Application No. 08/909,845 is a division of application No. 08/609,921, filed on Feb. 29, 1996, now Pat. No. 5,981,621.
Application No. 08/909,845 is a division of application No. 08/920,876, filed on Aug. 29, 1997, now Pat. No. 6,217,603.

(51) Int. Cl. B43K 8/22; B43K 8/16; B05C 21/00

(52) U.S. Cl. 401/132; 401/196

(57) ABSTRACT

An article of manufacture for dispensing a liquid adhesive includes an applicator body, a liquid adhesive contained within the applicator body, a porous applicator tip attached to the applicator body and in a non-contacting relationship with the liquid adhesive, and a polymerization initiator or rate modifier loaded in or on the applicator tip, wherein the polymerization initiator or rate modifier is selected from quaternary ammonium salts and tertiary amines. The liquid adhesive can also include a phase transfer catalyst.

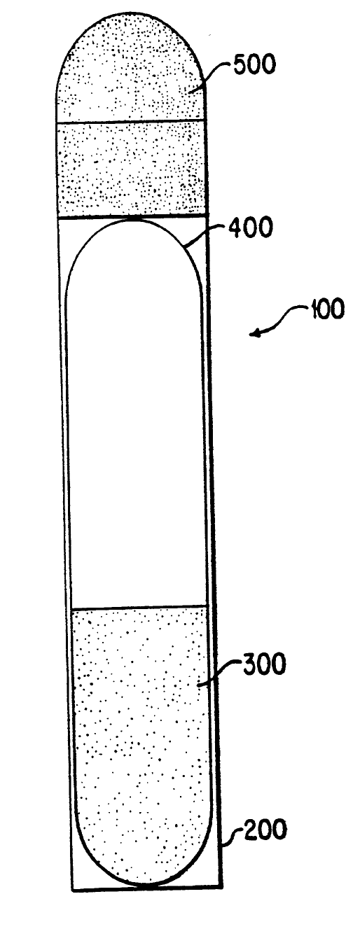

### CROSS-REFERENCE TO RELATED APPLICATIONS

This Application is a continuation-in-part of U.S. patent application Ser. No. 09/409,672, filed Sep. 30, 1999, which is a divisional application of U.S. patent application Ser. No. 09/221,997, filed Dec. 29, 1998, now U.S. Pat. No. 6,099,807, which in turn is a divisional application of U.S. patent application Ser. No. 08/488,411, filed Jun. 7, 1995, now U.S. Pat. No. 5,928,611. This Application is also a continuation-in-part of U.S. patent application Ser. No. 08/909,845, filed Aug. 12, 1997, which in turn is a divisional application of U.S. patent application Ser. No. 08/609,921, filed Feb. 29, 1996, now U.S. Pat. No. 5,982,621, and is a continuation-in-part of U.S. patent application Ser. No. 08/920,876, filed Aug. 29, 1997. The entire disclosure of the prior applications is hereby incorporated by reference herein in their entirety.

### BACKGROUND OF THE INVENTION

1. Field of Invention

The present invention relates to adhesive compositions and to adhesive applicators, particularly suitable for cyanoacrylate adhesives, with improved polymerization initiators and rate modifiers. The present invention is also related to methods for making such adhesive compositions and applicators.

2. Description of Related Art

Monomer and polymer adhesives are used in both industrial (including household) and medical applications. Included among these adhesives are the 1,1 -disubstituted ethylene monomers and polymers, such as the a-cyanoacrylates. Since the discovery of the adhesive properties of such monomers and polymers, they have found wide use due to the speed with which they cure, the strength of the resulting bond formed, and their relative ease of use. These characteristics have made the α-cyanoacrylate adhesives the primary choice for numerous applications such as bonding plastics, rubbers, glass, metals, wood, and, more recently, biological tissues.

It is known that monomeric forms of α-cyanoacrylates are extremely reactive, polymerizing rapidly in the presence of even minute amounts of an initiator, including moisture present in the air or on moist surfaces such as animal (including human) tissue. Monomers of α-cyanoacrylates are anionically polymerizable or free radical polymerizable, or polymerizable by zwitterions or ion pairs to form polymers. Once polymerization has been initiated, the cure rate can be very rapid.

Medical applications of 1,1-disubstituted ethylene adhesive compositions include use as an alternate or an adjunct to surgical sutures and/or staples in wound closure, as well as for covering and protecting surface wounds such as lacerations, abrasions, burns, stomatitis, sores, minor cuts and scrapes, and other wounds. When an adhesive is applied to surfaces to be joined, it is usually applied in its monomeric form, and the resultant polymerization gives rise to the desired adhesive bond.

Parent U.S. Pat. No. 5,928,611 to Leung discloses an applicator tip having a polymerization or cross-linking initiator or accelerator disposed on or in a solid support in the applicator tip. The patent also generally discloses that the initiator may be incorporated into the applicator during the fabrication of the tip, such as by mixing the initiator with the applicator material prior to molding the applicator tip material into the desired form. However, the specifics of and problems associated with this process are not set forth. The patent also discloses suitable initiators as including, for example, tetrabutyl ammonium bromide and amines.

Parent U.S. Pat. No. 5,982,621 to Clark et al. discloses biocompatible cyanoacrylate adhesive compositions that include a monomer, plasticizing agent, an acidic stabilizing agent and an initiator. The initiator may be applied to the surface of the applicator tip or may be impregnated or incorporated into the matrix or internal portions of the applicator tip. However, the specifics of and problems associated with this process are not set forth. The patent also discloses suitable initiators as including, for example, tetrabutyl ammonium bromide and amines.

U.S. Pat. No. 5,525,647 to Eichmiller discloses a method and a device for controllably affecting the reaction of dental adhesive. The device comprises an instrument or mixing container that has the reaction affecting compound deposited and affixed into or onto the surface thereof. The reaction affecting compound may be selected from the group consisting of a catalyst, a stabilizer, an antioxidant and an initiator. The instrument or mixing container may be selected from a bristle brush, sponge, absorptive pledget, or mixing well. Preferred co-initiators disclosed in the reference are secondary amines, aliphatic amines, or tertiary amines.

U.S. Pat. No. 4,291,131 to McIntire et al. discloses a nozzle for use on containers for holding cyanoacrylate adhesives, the nozzle being comprised of moldable material having an organic acid dispersed therein for inhibiting the polymerization of the adhesive within the nozzle. Suitable moldable materials include polyethylene, polypropylene, and crystallizable copolymers of polyethylene and polypropylene. Suitable acids include citric acid, tartaric acid, maleic acid and fumaric acid.

U.S. Pat. Nos. 5,514,371, 5,514,372, 5,575,997, 5,624,669, and 5,582,834 to Leung et al. disclose cyanoacrylate compositions, and suitable initiators for initiating polymerization of the cyanoacrylate compositions.

Despite the various known initiators and methods for applying the initiator to an applicator tip, a need continues to exist for improved designs, both in terms of the mode of application of the initiator, and the performance characteristics of the initiator.

For example, a commercial topical skin adhesive product available from Closure Medical Corporation, currently utilizes an aryl tri-alkyl ammonium salt as an initiator that is loaded onto the applicator tip. As the polymerizable monomeric adhesive material is expressed through the applicator tip, it becomes mixed with and initiated by the initiator. While this product has exhibited remarkable success, several areas of improvement have been noted with the materials. In particular, because the initiator is only loaded (i.e. absorbed) on the initiator tip, an amount of the initiator tends to fall off or be removed during processing and sterilization, resulting in a lesser amount of the initiator being available to initiate the monomer composition. This in turn requires either that a greater amount of initiator than otherwise necessary be loaded on the tip, or that variation in initiation properties be accepted.

### SUMMARY OF THE INVENTION

The present invention overcomes the above-described drawbacks by providing adhesive compositions and adhesive applicators, particularly suitable for cyanoacrylate adhesives, with improved polymerization initiators and rate modifiers. The present invention thereby provides applicators having a more consistent amount of available initiator, thereby providing more consistent set or cure times for the adhesive.

In particular, the present invention provides an article of manufacture for dispensing a liquid adhesive, said article comprising

an applicator body,

a liquid adhesive contained within said applicator body. For example, in a sealed or closed ampoule,

a porous applicator tip attached to said applicator body and in a non-contacting relationship with said liquid adhesive, and

a first polymerization initiator or rate modifier loaded in or on said applicator tip, wherein said first polymerization initiator or rate modifier is selected from the group consisting of quaternary ammonium salts and tertiary amines.

In embodiments of the present invention, the article of manufacture for dispensing a liquid adhesive, said article comprises:

an applicator body comprising a hollow, flexible cylinder,

an adhesive composition held within said applicator body that contains said liquid adhesive and a phase transfer catalyst, and

a porous applicator tip attached to said applicator body and through which said liquid adhesive is dispensed.

The present invention also provides a method of making such an article of manufacture, comprising: loading said first polymerization initiator or rate modifier into said porous applicator tip during manufacture of the porous applicator tip; disposing said adhesive material within said applicator body; and disposing said porous applicator tip at an open end of said applicator body.

The present invention also provides a polymerizable monomer adhesive composition, comprising:

a 1,1-disubstituted ethylene monomer;

an anionic stabilizing agent for said 1,1-disubstituted ethylene monomer; and

a phase transfer catalyst.

### BRIEF DESCRIPTION OF THE DRAWINGS

The Figure is a side elevational view of an applicator device that can be used according to the invention.

### DETAILED DESCRIPTION OF PREFERRED EMBODIMENTS

The Figure depicts an applicator device 100 suitable for use in the present invention. The applicator device 100 comprises a cylindrical applicator container 200 holding polymerizable and/or cross-linkable material 300 enclosed in a frangible vial 400, and an applicator tip 500 containing a polymerization and/or cross-linking initiator. The structure of this applicator, and other suitable applicators, is described in more detail in U.S. Pat. Nos. 5,928,611, 5,981,621 and 6,099,807, the entire disclosures of which are incorporated herein by reference. Moreover, the applicator is not limited to that shown in the Figure, but rather can be any applicator device suitable for application of a polymerizable monomeric adhesive composition. For example, other suitable applicator designs are described in U.S. patent applications Ser. Nos. 09/409,672, filed Sep. 30, 1999, 09/479,059, filed Jan. 7, 2000, 09/479,060, filed Jan. 7, 2000, and 09/506,255, filed Feb. 17, 2000, and U.S. Pat. No. 6,090,397, the entire disclosures of which are incorporated herein by reference.

According to the present invention, the initiator can be dispersed on or in the applicator tip. Suitable methods for loading (dispersing) the initiator onto or into the applicator tip are disclosed, for example, in U.S. Pat. No. 5,928,611 and U.S. patent application Ser. No. 09/430,177, filed Oct. 29, 1999, the entire disclosures of which are incorporated herein by reference.

The initiator may be applied to the surface of the applicator tip or may be impregnated or incorporated into the matrix or internal portions of the applicator tip. For example, the initiator may be applied to the applicator tip by spraying, dipping, or brushing the applicator tip with a liquid medium containing the initiator. The liquid medium may include non-aqueous solvents, such as ether, acetone, ethanol, pentane, a low boiling point solvent such as methanol, a low boiling point ketone or alcohol other than methanol, or mixtures thereof, or may include aqueous solutions. Preferably, the liquid medium is a low boiling point solvent.

The initiator may be applied to the applicator tip in the form of a preformed film of initiator. The initiator may be applied as a solid by vapor deposition such as by sputtering.

In embodiments, it is preferred that the initiator is incorporated into or onto the applicator tip during manufacture of the applicator tip. This avoids the necessity of a further step in producing the applicator of loading the initiator into or onto the tip. In these embodiments, the initiator can be physically or chemically supported on or in the tip. However, in embodiments of the present invention where improved initiator performance is desired, it is preferred that the initiator be chemically supported, i.e., chemically bonded, to the applicator tip material.

For example, the initiator may be incorporated into the applicator tip during the fabrication of the tip. This can be accomplished by mixing the initiator with the applicator tip material prior to molding or otherwise forming the applicator tip material into the desired form.

Where the initiator is incorporated into the applicator tip during its manufacture, the initiator can be incorporated at any suitable stage during the manufacturing process. For example, where the applicator tip is made by molding pellets of a polymeric substance, the initiator can be incorporated prior to, concurrent with, or subsequent to molding. For example, the initiator can be mixed with the pellets used to form the applicator tip, such that the mixture is molded to form the applicator tip. Alternatively, where the initiator is a liquid or can be dissolved into a suitable carrier liquid, the initiator can be absorbed or adsorbed into the pellets prior to molding, or can be applied as a release agent to the mold. For example, where the applicator tip is formed from a suitable polymeric material, such as polyethylene, the initiator can be mixed with the polyethylene prior to molding, and then the resultant mixture can be placed in an appropriate mold and molded accordingly. These processes provide alternative means to incorporate the initiator into the applicator tip, without need for a subsequent step of applying the initiator to it.

In a similar manner, in the case of a foam applicator tip, for example, the initiator can be incorporated into the foam during or after the foam formation. The initiator can be incorporated into the foam, for example, by introducing it into the foam during the blowing process, by adding it as a release agent to remove the foam from a mold, and the like.

In embodiments where the initiator is incorporated into the tip during the tip's manufacture, it is important that the initiator selected be compatible with both the applicator tip material as well as with the manufacturing process. For example, where the manufacturing process involves the use of elevated temperatures, the initiator must not decompose or evaporate off, or at least must not decompose into non-initiator species, as a result of the elevated temperatures. Likewise, the initiator should be compatible with other chemical species that may be present during manufacture of the tip, such as blowing and expansion agents, lubricants, and the like. Thus, for example, while aryl tri-alkyl ammonium salts tend to decompose at high pressures, other initiators such as other quaternary ammonium salts and tertiary amines, do not decompose.

In embodiments of the present invention, whether the initiator is incorporated into the tip during the tip's manufacture or afterwards, it is preferred that the initiator be chemically bonded to the material forming the applicator tip. That is, it is preferred in embodiments that the initiator be a polymer supported initiator. However, in other embodiments, the initiator can be absorbed or adsorbed in or on the applicator tip, if desired.

Where the initiator is used in the form of a polymer supported initiator, it is preferred in embodiments that the polymer support be a basic resin. Examples of suitable basic resins suitable for forming the polymer support include, but are not limited to, divinylbenzene/vinyl pyridine copolymer. In embodiments, the polymer support can alternatively include a halide on a polymer support. Preferably, the polymer supported initiator is also cross-linked. Examples of suitable polymer supports include, for example, the DOWEX® materials available from Dow Chemicals and the AMBERLYST® materials available from Rohm and Haas. In use, the strongly basic resins act by deprotonating compounds having acidic protons present in the monomer. Likewise, in use, the halide supported resin initiation is due to the presence of the free halide, or counter ion of a quaternary ammonium based polymer. As will be apparent to those skilled in the art, the rate of initiation provided by such materials will be related, and thus can be controlled by, the degree of functionalization of the polymer support.

Particular initiators for particular adhesive composition systems may be readily selected by one of ordinary skill in the art without undue experimentation. Suitable initiators include, but are not limited to, detergent compositions; surfactants: e.g., nonionic surfactants such as polysorbate 20 (e.g., Tween 20™ surfactant), polysorbate 80 surfactant (e.g., Tween 80™ surfactant) and poloxamers, cationic surfactants such as tetrabutylammonium bromide and tetrabutylammonium chloride, anionic surfactants such as sodium tetradecyl sulfate, and amphoteric or zwitterionic surfactants such as dodecyldimethyl(3-sulfopropyl)ammonium hydroxide, inner salt; amines, imines and amides, such as imidazole, tryptamine, urea, arginine and povidine; phosphines, phosphites and phosphonium salts, such as triphenylphosphine and triethyl phosphite; alcohols such as ethylene glycol, methyl gallate, ascorbic acid, tannins and tannic acid; inorganic bases and salts, such as sodium bisulfite, magnesium hydroxide, calcium sulfate and sodium silicate; sulfur compounds such as thiourea and polysulfides; polymeric cyclic ethers such as monensin, nonactin, crown ethers, calixarenes and polymeric epoxides; cyclic and acyclic carbonates, such as diethyl carbonate; phase transfer catalysts such as Aliquat 336; organometallics such as cobalt naphthenate and manganese acetylacetonate; and radical initiators and radicals, such as di-t-butyl peroxide and azobisisobutyronitrile.

The polymerizable and/or cross-linkable material may also contain an initiator which is inactive until activated by a catalyst or accelerator (included within the scope of the term “initiator” as used herein) in the applicator tip. For example, monomer containing benzoyl peroxide may be used as a polymerizable material in association with a tip containing an amine accelerator, or monomer containing methyl ethyl ketone peroxide may be used as a polymerizable material in association with a tip containing cobalt naphthenate. Initiators activated by stimulation such as heat and/or light (e.g., ultraviolet or visible light) are also suitable if the tip and/or applicator is appropriately subjected to such stimulation.

According to embodiments of the present invention, a particularly suitable class of initiators are quaternary ammonium salts, tertiary amines, and other strong anion exchange resins. Suitable quaternary ammonium salts include, but are not limited to, tetraalkylammonium halides where the alkyl chain is from about 1 to about 20 carbon atoms, such as tetrabutylammonium bromide and tetrabutylammonium chloride; ether amine quaternaries; quaternary ammonium sulfate salts; quaternary ammonium bisulfate salts; benzalkonium chloride; and the like.

In general, quaternary ammonium salts can be represented by the following formulas:

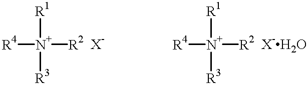

where X⁻can be selected from, for example, Cl⁻, F⁻, Br⁻, I⁻, SO₄⁻, HSO₄⁻, OH⁻, and the like; and R¹, R², R³, and R⁴ can be the same or different and can be selected from, for example, alkyl groups, aryl groups, aralkyl groups, and the like having from 1 to about 20 carbon atoms. As shown in the above formulas the quaternary ammonium salts can include water of hydration and/or crystallization.

Examples of suitable ether amine quaternaries include, but are not limited to, compounds of the following formula (I):

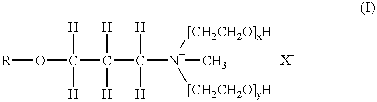

where R is a straight or branched alkyl group of from about 2 to about 20 carbon atoms, preferably from about 4 to about 16 carbon atoms; x and y represent the number of repeating units and independently are integers of from 1 to about 10, preferably from 1 to about 3, 4, or 5; and X is a counterion selected from, for example, halides such as chloride, bromide, iodide, and fluoride, sulfate, hydrogen sulfate, sulfite, hydrogen sulfite, bisulfate, bisulfite, hydroxide, and the like. Suitable examples of such ether amine quaternaries of formula (I) include, but are not limited to, the products Q-14-2 and Q-14-2 PG (isodecyloxypropyl dihydroxyethylmethyl ammonium chloride, where R is branched C₁₀H₂₁, X is chloride and x and y yield a molecular weight of about 370), Q-17-2 and Q-17-2 PG (isotridecyloxypropyl dihydroxyethylmethyl ammonium chloride, where R is branched C₁₃H₂₇, X is chloride and x and y yield a molecular weight of about 410), and Q-17-5 (isotridecyloxypropyl poly(5) oxyethylene methyl ammonium chloride, where R is branched C₁₃H₂₇, X is chloride and x and y yield a molecular weight of about 535), all available from the Tomah3 company.

Suitable polymeric tertiary amines include, but are not limited to, the DOWEX® materials available from Dow Chemicals, and the like. Suitable strong anion exchange resins include, but are not limited to, the Amberlyst® materials, available from Rohm & Haas, particularly Amberlyst(® A-26, and the like.

Particularly preferred among the quaternary ammonium salts are quaternary ammonium sulfate salts and quaternary ammonium bisulfate salts, such as quaternary ammonium hydrogen sulfates and quaternary ammonium hydrogen bisulfates. Examples of such compounds include, but are not limited to, tetrabutyl ammonium sulfate, tetrabutyl ammonium bisulfate, tetrabutyl ammonium hydrogen sulfate, tetrabutyl ammonium hydrogen bisulfate, tetrabutyl ammonium carbonate, tetrabutyl ammonium bicarbonate, tetrabutyl ammonium sulfite, tetrabutyl ammonium bisulfite, and the like.

A particular advantage of the quaternary ammonium sulfate and quaternary ammonium bisulfate salts is that they operate as phase transfer catalysts in applicators of the present invention. That is, in the form of sulfate and bisulfate salts, the compounds are relatively non-reactive, due to the weak nucleophilic properties of the sulfate and bisulfate ions. As such, these compounds can be incorporated either into or onto an applicator tip, without resulting in any undesired reactions with other components. Because sulfate and bisulfate are weak nucleophiles, the compounds will not adversely react with other components of the applicator. However, once the composition is expressed out of the applicator and onto a tissue surface, the sulfate and bisulfate ions will exchange with stronger, more potent nucleophilic groups, such as chloride, bromide, acetate, conjugate base of a weak acid, nucleic acid, and the like, which are typically present in and on tissue surfaces. Once this nucleophilic substitution takes place, the phase transfer catalyst becomes a strong initiator for the polymerizable monomer composition, causing the composition to rapidly polymerize to form a polymer film. A further description of such phase transfer catalysts can be found in, for example, J. March, Advanced Organic Chemistry. 3^{rd} Ed., New York: John Wiley & Sons, pp. 320-322; P. J. Garegg et al., Carbohydrate Research, Vol. 130, p. 322 (1984); and R. Thompson, The Design and Synthesis of Antimicrofilaria and Anticancer Compounds, MS Thesis, University of Tennessee, Part 2.B, “Benzylation of O-Cyclohexyliden Derivates of myo-Inositol,” August 1994, the entire disclosures of which are incorporated herein by reference.

Also particularly preferred among the quaternary ammonium salts are such salts that are soluble in the monomer used in the adhesive composition. Thus, for example, particularly preferred are ether amine quaternaries, such as the ether amine quaternaries of formula (I) above. A particular advantage of the quaternary ammonium salts that exhibit increased solubility in the monomer is the ability of the quaternary ammonium salts to more quickly initiate polymerization of the monomer. Thus, for example, a quaternary ammonium salt such as the ether amine quaternaries that is more soluble in the monomer, as compared to benzalkonium chloride, which is less soluble in the monomer, will more quickly and homogeneously initiate polymerization of the monomer. This difference indicates that the tetrabutyl ammonium salts such as tetrabutyl ammonium chloride dissolves into the polymerizable monomer better than benzalkonium chloride. This in turn enables faster setting of the monomer. In addition, in embodiments where multiple layering of the adhesive composition may be desired, the faster setting more easily permit multiple layering of the adhesive composition.

In embodiments when exchange resins are used in the present invention, the exchange resin can be either an anion or a cation exchange resin, as desired. When so incorporated, the exchange resin can be located in any suitable location in the applicator, or in a kit containing the applicator. Thus, for example, the exchange resin can be formed as small beads or particles, or can be loaded on or in small beads or particles. The small beads or particles can be of any suitable size and shape including, but not limited to, spherical, substantially spherical, elongated, rod-shapes, or the like.

When the exchange resin is used as an initiator species for the liquid adhesive material, the exchange resin can be located in the same container as the liquid adhesive composition, such as in the form of a phase transfer catalyst as described below, or the exchange resin can be located outside of the container that contains the liquid adhesive composition. For example, although not limited thereto, in the embodiment shown in the Figure, the exchange resin can be located inside of the cylindrical applicator container 200, but outside of the frangible vial 400; the exchange resin can be located in or on the applicator tip 500; and/or the exchange resin can be located in a separate container, such as a vial, drum, pouch, envelope or the like, that is separate from the applicator device 100, although typically and preferably included in a kit along with the applicator device.

If desired, a screening or filtering member can be inserted in the applicator device, such as to prevent beads or particles of the exchange resin from being expressed with the liquid adhesive. Thus, for example, such a screening of filtering member can be placed in the applicator device between the inner frangible vial and the applicator tip. In other embodiments, however, such a filtering or screening member may not be necessary, and instead the beads or particles of the exchange resin can be expressed along with the liquid adhesive composition.

Additionally, or alternatively, one or more of the above-described compounds can be incorporated directly into the adhesive composition. As above, because sulfate and bisulfate are weak nucleophiles, and because sulfates are generally already present in the adhesive compositions due to the common inclusion of sulfate-based anionic stabilizers, the compounds will not adversely react with the polymerizable monomers, and will not cause premature polymerization. However, once the nucleophilic substitution occurs upon application to tissue, the phase transfer catalyst becomes a strong initiator for the polymerizable monomer composition, causing the composition to rapidly polymerize to form a polymer film.

According to other embodiments of the present invention, initiator can be added to the applicator tip both during the tip's manufacture, as well as at a later stage. Or, in embodiments where the initiator is added directly to the adhesive composition in the form of a phase transfer catalyst, a further amount of the same or different initiator can also be added to the applicator tip. Thus, for example, an amount of initiator can be added to the applicator tip subsequent to the tip's manufacture as a means to fine-tune or adjust the initiation properties of the composition provided by another initiator component.

The amount of initiator used in the present invention will generally depend upon the desired monomer and desired initiator being used, the type of applicator and applicator tip being used, and other process conditions. However, generally, the amount of initiator applied to the applicator tip may vary from about 0.0001 to as high as 50% by weight of the polymerizable monomer composition. Preferably, in embodiments, the initiator is present in an amount of from 0.001 to 25%, and more preferably from 0.01 to 10% by weight. Likewise, the amount of initiator incorporated directly into the adhesive composition may vary from about 0.0001 to as high as 50% by weight of the polymerizable monomer composition. Preferably, in embodiments, the initiator is present in an amount of from 0.001 to 10%, and more preferably from 0.005 to 3% by weight. Of course, amounts outside these ranges may be acceptable in embodiments.

In embodiments of the present invention, as described above, an exchange resin can be incorporated into the applicator device and/or the liquid adhesive composition. If desired, such an exchange resin can alternatively be selected to provide stabilization, rather than polymerization initiation, effects. Thus, for example, suitable cation exchange resins can be incorporated into the adhesive composition as a stabilizer for the liquid adhesive, either in place of or in addition to the stabilizers described in more detail below.

As above, such an exchange resin can be formed as small beads or particles, or can be loaded on or in small beads or particles. The small beads or particles can be of any suitable size and shape including, but not limited to, spherical, substantially spherical, elongated, rod-shapes, or the like.

When the exchange resin is used as a stabilizer species for the liquid adhesive material, the exchange resin is preferably located in the same container as the liquid adhesive composition. For example, although not limited thereto, in the embodiment shown in the Figure, the exchange resin can be located inside of the frangible vial 400.

If desired, a screening or filtering member can be inserted in the applicator device, such as to prevent beads or particles of the exchange resin from being expressed with the liquid adhesive. Thus, for example, such a screening of filtering member can be placed in the applicator device between the inner frangible vial and the applicator tip. In other embodiments, however, such a filtering or screening member may not be necessary, and instead the beads or particles of the exchange resin can be expressed along with the liquid adhesive composition.

In embodiments, the monomer composition and/or its packaging are preferably sterilized. Sterilization of the monomer composition and/or its packaging can be accomplished by techniques known to one of ordinary skill in the art, and is preferably accomplished by methods including, but not limited to, chemical, physical, and/or irradiation methods. Examples of chemical methods include, but are not limited to, exposure to ethylene oxide or hydrogen peroxide vapor. Examples of physical methods include, but are not limited to, sterilization by heat (dry or moist) or retort canning. Examples of irradiation methods include, but are not limited to, gamma irradiation, electron beam irradiation, and microwave irradiation. A preferred method is electron beam irradiation, as described in U.S. patent application Ser. No. 09/025,472, filed on Feb. 18, 1998, the entire disclosure of which is incorporated herein by reference. The composition must show low levels of toxicity to living tissue during its useful life. In preferred embodiments of the present invention, the composition is sterilized to provide a Sterility Assurance Level (SAL) of at least 10⁻³. In embodiments, the Sterility Assurance Level may be at least 10⁻⁴, or may be at least 10⁻⁵, or may be at least 10⁻⁶.

The monomer (including prepolymeric) adhesive composition may include one or more polymerizable monomers. Preferred monomers that may be used in this invention are readily polymerizable, e.g. anionically polymerizable or free radical polymerizable, or polymerizable by zwitterions or ion pairs to form polymers. Such monomers include those that form polymers, that may, but do not need to, biodegrade. Such monomers are disclosed in, for example, U.S. Pat. Nos. 5,328,687 and 5,928,611 to Leung et al., U.S. patent application Ser. No. 09/430,177, filed on Oct. 29, 1999, and U.S. patent application Ser. No. 09/471,392 filed Dec. 23, 1999, which are hereby incorporated in their entirety by reference herein. Preferred monomers include 1,1-disubstituted ethylene monomers, such as α-cyanoacrylates including, but not limited to, alkyl α-cyanoacrylates having an alkyl chain length of from about 1 to about 20 carbon atoms or more, preferably from about 3 to about 8 carbon atoms.

The α-cyanoacrylates of the present invention can be prepared according to several methods known in the art. U.S. Pat. Nos. 2,721,858, 3,254,111, 3,995,641, and 4,364,876, each of which is hereby incorporated in its entirety by reference herein, disclose methods for preparing α-cyanoacrylates.

The composition may optionally also include at least one other plasticizing agent that assists in imparting flexibility to the polymer formed from the monomer. The plasticizing agent preferably contains little or no moisture and should not significantly affect the stability or polymerization of the monomer. Examples of suitable plasticizers include but are not limited to acetal trihexyl citrate, cetyl trihexyl citrate, fatty acid esters, tributyl citrate, acetyl tri-n-butyl citrate (ATBC), polymethylmethacrylate, polydimethylsiloxane, hexadimethylsilazane and others as listed in U.S. patent application Ser. No. 09/471,392 filed Dec. 23, 1999, the disclosure of which is incorporated in its entirety by reference herein.

The composition may also optionally include at least one thixotropic agent. Suitable thixotropic agents are known to the skilled artisan and include, but are not limited to, silica gels such as those treated with a silyl isocyanate, and optionally surface treated titanium dioxide. Examples of suitable thixotropic agents and thickeners are disclosed in, for example, U.S. Pat. No. 4,720,513, and U.S. patent application Ser. No. 09/374,207 filed Aug. 12, 1999, the disclosures of which are hereby incorporated in their entireties by reference herein.

The composition may optionally also include thickeners. Suitable thickeners may include poly (2-ethylhexy methacrylate), poly(2-ethylhexyl acrylate) and others as listed in U.S. patent application Ser. No. 09/472,392 filed Dec. 23, 1999, the disclosure of which is incorporated by reference herein in its entirety.

The composition may also optionally include at least one natural or synthetic rubber to impart impact resistance. Suitable rubbers are known to the skilled artisan. Such rubbers include, but are not limited to, dienes, styrenes, acrylonitriles, and mixtures thereof. Examples of suitable rubbers are disclosed in, for example, U.S. Pat. Nos. 4,313,865 and 4,560,723, the disclosures of which are hereby incorporated in their entireties by reference herein.

The composition may optionally also include one or more stabilizers, preferably both at least one anionic vapor phase stabilizer and at least one anionic liquid phase stabilizer. These stabilizing agents may inhibit premature polymerization. Suitable stabilizers may include those listed in U.S. patent application Ser. No. 09/471,392 filed on Dec. 23, 1999, the disclosure of which is incorporated by reference herein in its entirety. Furthermore, certain stabilizers may also function as anti-fungal agents, such as, for example, various acidic anti-fungals, as identified above. Other stabilizing agents, such as various free radical stabilizing agents, can also be used alone or in combination with the above stabilizers. Suitable free radical stabilizing agents are disclosed in, for example, U.S. patent application Ser. No. 09/099,457, filed Jun. 18, 1998, the entire disclosure of which is incorporated by reference herein.

The stability, and thus the shelf-life, of some monomeric adhesive compositions can be further enhanced and extended through careful regulation of the packaging. Treated (e.g., fluorinated polymer) packaging such as that disclosed in copending U.S. patent application Ser. No. 09/430,289, filed Oct. 29, 1999, which is hereby incorporated by reference herein in its entirety, is preferred and may reduce the amount of stabilizer that is combined into the composition. As mentioned above, certain stabilizers including, but not limited to, certain acidics can also function as anti-fungal agents. In this case, the amount of the anti-fungal/stabilizer material is either not reduced below a level to provide the desired anti-fungal effect, or a further anti-fungal/non-stabilizing agent is added to ensure that the desired anti-fungal effect is provided.

The compositions may also include pH modifiers to control the rate of degradation of the resulting polymer, as disclosed in U.S. patent application Ser. No. 08/714,288, filed Sep. 18, 1996, the entire disclosure of which is hereby incorporated by reference herein in its entirety.

Compositions of the present invention may also include at least one biocompatible agent effective to reduce active formaldehyde concentration levels produced during in vivo biodegradation of the polymer (also referred to herein as “formaldehyde concentration reducing agents”). Preferably, this component is a formaldehyde scavenger compound. Examples of formaldehyde scavenger compounds useful in this invention include sulfites; bisulfites; mixtures of sulfites and bisulfites, etc. Additional examples of formaldehyde scavenger compounds useful in this invention and methods for their implementation can be found in U.S. Pat. Nos. 5,328,687, 5,514,371, 5,514,372, 5,575,997, 5,582,834 and 5,624,669, all to Leung et al., which are hereby incorporated herein by reference in their entireties.

To improve the cohesive strength of adhesives formed from the compositions of this invention, difunctional monomeric cross-linking agents may be added to the monomer compositions of this invention. Such crosslinking agents are known. U.S. Pat. No. 3,940,362 to Overhults, which is hereby incorporated herein in its entirety by reference, discloses exemplary cross-linking agents.

The compositions of this invention may further contain fibrous reinforcement and colorants such as dyes, pigments, and pigment dyes. Examples of suitable fibrous reinforcement include PGA microfibrils, collagen microfibrils, and others as described in U.S. patent application Ser. No. 09/471,392 filed on Dec. 23, 1999, the disclosure of which is incorporated by reference herein in its entirety.

The polymerizable compositions useful in the present invention may also further contain one or more preservatives, for prolonging the storage life of the composition. Suitable preservatives, and methods for selecting them and incorporating them into adhesive compositions, are disclosed in U.S. patent application Ser. No. 09/430,180, the entire disclosure of which is incorporated herein by reference. Such preservatives can be in addition to any anti-fungal agent that may or may not be added to the composition, as described above.

In embodiments of the present invention, the composition and/or its applicator may contain additional materials such as a polymerization initiator, accelerator, rate-modifier, and/or cross-linking agent for initiating polymerization and/or cross-linking of the polymerizable monomer material. Such initiators, accelerators, rate-modifiers, and/or cross-linking agents can be included in addition to the above-described initiator or phase transfer catalyst, and be included in the applicator tip, in the polymerizable composition, and/or elsewhere, as appropriate.

Suitable materials and applicators and packaging systems are disclosed in U.S. Pat. No. 5,928,611 and U.S. patent applications Ser. Nos. 09/430,177, 09/430,176, 09/430,289, 09/430,290, and 09/430,180 filed Oct. 29, 1999; 09/343,914 filed Jun. 30, 1999; 09/385,030 filed Aug. 30, 1999; and 09/176,889 filed Oct. 22, 1998; the entire disclosures of which are incorporated herein by reference.

The following examples illustrate specific embodiments of the present invention. One skilled in the art will recognize that the appropriate reagents, and component ratios/concentrations may be adjusted as necessary to achieve specific product characteristics. All parts and percentages are by weight unless otherwise indicated.

### EXAMPLE

### Examples 1-3

Various applicators including 2-octyl cyanoacrylate monomer compositions are prepared with varying amounts and types of initiator loaded on an applicator tip. The adhesive compositions all include a stabilized 2-octyl cyanoacrylate adhesive composition. In each Example, 2 mL of the 2-octyl cyanoacrylate monomer composition is sealed in a glass vial and the vial is placed into an applicator such as shown in the Figure. An applicator tip is attached to the applicator tube.

In Examples 1-3, the initiator applied to the applicator tip is tetrabutyl ammonium chloride, applied using acetone as a solvent. The amount of initiator applied in Examples 1, 2 and 3 is 70 ppm, 100 ppm and 120 ppm, respectively, based on the amount of 2-octyl cyanoacrylate adhesive composition.

Drops of the compositions are applied from the applicators by crushing the vial and expressing the monomer composition through the applicator tip. The compositions are analyzed to determine the cure time and cure temperature of the composition. Cure temperature represents the highest temperature that the composition reaches during curing. Testing for each of the compositions of Examples 1-3 is repeated seven times, and the results are shown as averages in Table 1 below.

### Comparative Examples 1-3

The testing of Examples 1-3 is repeated, except that benzalkonium chloride is used as the initiator instead of tetrabutyl ammonium chloride. The amount of initiator in Comparative Examples 1, 2 and 3 is 70, 100 and 120 ppm, respectively. The results are shown in Table 1 below.

TABLE 1

| | Initiator | Cure Time | Cure Temperature |
|---|---|---|---|
| Example | Concentration | (sec.) | (° C.) |
| 1 | 70 | 41 | 66 |
| 2 | 100 | 34 | 84 |
| 3 | 120 | 20 | 89 |
| Comp. 1 | 70 | 67 | 54 |
| Comp. 2 | 100 | 42 | 74 |
| Comp. 3 | 120 | 34 | 84 |

The results in Table 1 demonstrate that the use of tetrabutyl ammonium chloride as an initiator provides a significantly faster cure time than does benzalkonium chloride. The data also shows that for a desired cure time, a significantly lower amount of tetrabutyl ammonium chloride can be used in place of benzalkonium chloride.

### Example 4-5

The testing of Examples 1-3 is repeated, except that methanol is used as a solvent to apply the tetrabutyl ammonium chloride initiator. The amount of initiator in Example 4 and 5 is 70 and 100 ppm, respectively. The results are shown in Table 2 below

### Comparative Examples 4-5

The testing of Examples 4-5 is repeated, except that methanol is used as a solvent to apply the benzalkonium chloride initiator. The amount of initiator in Comparative Examples 4 and 5 is 70 and 100 ppm, respectively. The results are shown in table 2 below.

TABLE 2

| | Initiator | Cure Time | Cure Temperature |
|---|---|---|---|
| Example | Concentration | (sec.) | (° C.) |
| 4 | 70 | 48 | 63 |
| 5 | 100 | 37 | 62 |
| Comp. 4 | 70 | 75 | 54 |
| Comp. 5 | 100 | 39 | 72 |

The results in Table 2 also demonstrate that the use of tetrabutyl ammonium chloride as an initiator provides a significantly faster cure time than does benzalkonium chloride. The data also shows that for a desired cure time, a significantly lower amount of tetrabutyl ammonium chloride can be used in place of benzalkonium chloride.

### Examples 6-11:

The testing of Examples 1-3 is repeated, using either acetone or methanol as a solvent to apply the tetrabutyl ammonium chloride initiator. The amount of initiator in each of Examples 6-11 is 180 ppm. In Examples 6, 7, 8 and 10, the monomer composition is not subjected to a sterilization treatment. In Examples 9 and 11, the monomer composition is subjected to a sterilization treatment. Testing is conducted according to Examples 1-3, above. The results are shown in Table 3 below.

TABLE 3

| | | | | Cure |
|---|---|---|---|---|
| | | | Cure Time | Temperature |
| Example | Solvent | Sterile? | (sec.) | (° C.) |
| 6 | Acetone | No | 9 | 95 |
| 7 | Methanol | No | 12 | 94 |
| 8 | Acetone | No | 5 | 98 |
| 9 | Acetone | Yes | 11 | 96 |
| 10 | Methanol | No | 6 | 92 |
| 11 | Methanol | Yes | 13 | 83 |

### Examples 12-23:

Various applicators including 2-octyl cyanoacrylate monomer compositions are prepared with varying amounts and types of initiator loaded on an applicator tip. The adhesive compositions all include a stabilized 2-octyl cyanoacrylate adhesive composition. In each Example, 2 mL of the 2-octyl cyanoacrylate monomer composition is sealed in a glass vial and the vial is placed into an applicator such as shown in the Figure. An applicator tip is attached to the applicator tube.

In these Examples, the applicator tip is formed such that the initiator is incorporated directly into the tip material during molding of the tip material. The type and amount of initiator is shown in Table 4 below. Percent loading of the initiator is based on total weight of the applicator tip.

The initiators used in these Examples are as follows:

A—DOWEX—a strongly basic ion exchange resin available from Dow Chemicals

B—TBAHS—tetrabutyl ammonium hydrogen sulfate

C—992318—an ion exchange resin

D—IRA-67—a weakly basic ion exchange resin available from Rohm & Haas

E—Amberlyst A-26—a fluoride polymer-supported resin

In Examples 12-17 and 20-23, the applicator tip is sealed to the applicator tube by applying 110 μL of acetone to the tip. The acetone causes solvent bonding to seal the tip to the tube. In Examples 18-19, the applicator tip is sealed to the applicator tube by applying 110 μL of acetone containing 180 ppm benzalkonium chloride to the tip. The acetone causes solvent bonding to seal the tip to the tube, while the benzalkonium chloride remains in the tip to act as an additional initiator for the adhesive composition.

Drops of the compositions are applied from the applicators by crushing the vial and expressing the monomer composition through the applicator tip. The compositions are analyzed to determine the cure time and cure temperature of the composition. Testing for each of the compositions is repeated four times, and the results are shown as Averages Table 4 below.

TABLE 4

| | | | | Cure |
|---|---|---|---|---|
| | | Concentration | Cure Time | Temperature |
| Example | Initiator | (wt. %) | (sec.) | (° C.) |
| 12 | A | 0.5 | 150 | 23 |
| 13 | A | 2.0 | 150 | 23 |
| 14 | B | 0.5 | 137 | 22 |
| 15 | B | 2.0 | 43 | 57 |
| 16 | C | 0.5 | 150 | 22 |
| 17 | C | 2.0 | 150 | 22 |
| 18 | B | 0.5 | 41 | 62 |
| 19 | B | 2.0 | 13 | 82 |
| 20 | D | 0.5 | 150 | 23 |
| 21 | D | 2.0 | 150 | 23 |
| 22 | E | 0.5 | 150 | 23 |
| 23 | E | 2.0 | 150 | 23 |

### Comparative Example 6:

Following the procedure of Examples 12-23 above, benzalkonium chloride is used as the initiator being molded directly into the applicator tip during manufacture of the tip. However, due to the molding temperature in excess of 200° C, the benzalkonium chloride is decomposed, and the experiment is halted.

### Example 24:

Following the procedure of Examples 12-23 above, an ether amine quaternary ammonium salt is used as the initiator and is applied to an applicator tip. The amount of initiator applied is 180 ppm, based on the amount of 2-octyl cyanoacrylate adhesive composition.

Drops of the compositions are applied from the applicators by crushing the vial and successively drop-wise expressing the monomer composition through the applicator tip. The composition is analyzed after each drop to determine the cure time and cure temperature of the composition. The results are shown as averages in Table 5 below.

TABLE 5

| | Cure Time | Cure Temperature |
|---|---|---|
| Drop | (sec.) | (° C.) |
| 1 | 63.2 | 88 |
| 2 | 76.1 | 88 |
| 3 | 78.9 | 89 |
| 4 | 87.5 | 85 |

This Example demonstrates that the ether amine quaternary ammonium salt exhibits high solubility in the cyanoacrylate monomer. The increased solubility allows for more easy layering of the polymer material on a substrate.

While the invention has been described with reference to preferred embodiments, the invention is not limited to the specific examples given, and other embodiments and modifications can be made by those skilled in the art without departing from the spirit and scope of the invention.

What is claimed is:

1. An article of manufacture for dispensing a liquid adhesive, said article comprising
an applicator body,
a liquid adhesive contained within said applicator body,
a porous applicator tip attached to said applicator body and in a non-contacting relationship with said liquid adhesive, and
a first polymerization initiator or rate modifier loaded in or on said applicator tip, wherein said first polymerization initiator or rate modifier is selected from the group consisting of quaternary ammonium salts and tertiary amines.

2. The article of manufacture of claim 1, further comprising a frangible vial held within said applicator body, and wherein said liquid adhesive is contained within said frangible vial.

3. The article of manufacture of claim 1, wherein said first polymerization initiator or rate modifier is a tetraalkyl ammonium halide.

4. The article of manufacture of claim 1, wherein said first polymerization initiator or rate modifier is a tetrabutyl ammonium halide.

5. The article of manufacture of claim 1, wherein said first polymerization initiator or rate modifier is tetrabutyl ammonium chloride.

6. The article of manufacture of claim 1, wherein said first polymerization initiator or rate modifier is selected from the group consisting of quaternary ammonium salts.

7. The article of manufacture of claim 1, wherein said first polymerization initiator or rate modifier is selected from the group consisting of quaternary ammonium salts other than benzalkonium chloride.

8. The article of manufacture of claim 7, wherein said first polymerization initiator or rate modifier is a quaternary ammonium salt represented by one of the following formula: 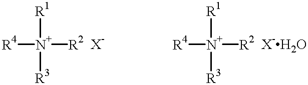
wherein X⁻ is selected from the group consisting of Cl⁻, F⁻, Br⁻, I⁻, SO₄⁻, HSO₄⁻, and OH⁻; and R¹, R², R³, and R⁴ are the same or different and are selected from the group consisting of alkyl groups, aryl groups, and aralkyl groups having from 1 to about 20 carbon atoms.

9. The article of manufacture of claim 1, wherein said first polymerization initiator or rate modifier is an ether amine quaternary compound.

10. The article of manufacture of claim 9, wherein said ether amine quaternary compound is a compound of formula (I): 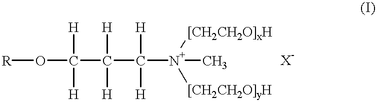
wherein R is a straight or branched alkyl group of from about 2 to about 20 carbon atoms, x and y independently represent an integer of from 1 to about 10, and X is a counterion.

11. The article of manufacture of claim 10, wherein said counterion is selected from the group consisting of chloride, fluoride, iodide, bromide, sulfate, hydrogen sulfate, sulfite, hydrogen sulfite, bisulfite, carbonate, and bicarbonate.

12. The article of manufacture of claim 1, wherein said first polymerization initiator or rate modifier is selected from the group consisting of quaternary ammonium sulfates and quaternary ammonium bisulfates.

13. The article of manufacture of claim 1, wherein said first polymerization initiator or rate modifier is selected from the group consisting of quaternary ammonium hydrogen sulfates and quaternary ammonium hydrogen bisulfates.

14. The article of manufacture of claim 1, wherein said first polymerization initiator or rate modifier is selected from the group consisting of tetrabutyl ammonium sulfates and tetrabutyl ammonium bisulfates.

15. The article of manufacture of claim 1, wherein said first polymerization initiator or rate modifier is selected from the group consisting of tetrabutyl ammonium hydrogen sulfate and tetrabutyl ammonium hydrogen bisulfate.

16. The article of manufacture of claim 1, wherein said first polymerization initiator or rate modifier is selected from the group consisting of tertiary amines.

17. The article of manufacture of claim 1, wherein said first polymerization initiator or rate modifier is soluble in said liquid adhesive.

18. The article of manufacture of claim 1, wherein said liquid adhesive comprises 1,1-disubstituted ethylene monomer.

19. The article of manufacture of claim 1, wherein said liquid adhesive comprises a cyanoacrylate monomer.

20. The article of manufacture of claim 1, wherein said liquid adhesive further comprises at least one plasticizer.

21. The article of manufacture of claim 20, wherein said plasticizer is selected from the group consisting of acetal trihexyl citrate, cetyl trihexyl citrate, fatty acid esters, tributyl citrate, acetyl tri-n-butyl citrate, polymethylmethacrylate, polydimethylsiloxane, and hexadimethylsilazane.

22. The article of manufacture of claim 1, wherein said first polymerization initiator or rate modifier is chemically bonded to a material forming said porous applicator tip.

23. The article of manufacture according to claim 22, wherein said applicator tip comprises a polymerized material.

24. The article of manufacture according to claim 22, wherein said applicator tip comprises a material selected from the group consisting of metal, glass, paper, ceramics, and cardboard.

25. The article of manufacture according to claim 22, wherein said applicator tip comprises a plastics material.

26. The article of manufacture according to claim 22, wherein said applicator tip is at least one of porous, absorbent and adsorbent in nature.

27. The article of manufacture according to claim 22, further comprising a second polymerization initiator or rate modifier loaded in or on said applicator tip, wherein said second polymerization initiator or rate modifier is different from said first polymerization initiator or rate modifier.

28. The article of manufacture according to claim 27, wherein said first and second polymerization initiator or rate modifier each initiates or modifies a rate of polymerization of said liquid adhesive.

29. The article of manufacture according to claim 27, wherein said second polymerization initiator or rate modifier comprises benzalkonium chloride.

30. The article of manufacture according to claim 27, wherein said second polymerization initiator or rate modifier is adsorbed or absorbed on said porous applicator tip.

31. A method of making the article of manufacture of claim 1, comprising:
loading said first polymerization initiator or rate modifier into said porous applicator tip during manufacture of the porous applicator tip;
disposing said liquid adhesive within said applicator body; and
disposing said porous applicator tip at an open end of said applicator body.

32. The method of claim 31, wherein said loading step comprises mixing said first polymerization initiator or rate modifier with a precursor material of said porous applicator tip.

33. The method of claim 32, wherein said mixing is conducted prior to molding said porous applicator tip.

34. The method of claim 31, wherein said initiator is selected from the group consisting of tetrabutylammonium bromide, sodium tetradecyl sulfate, dodecyldimethyl(3-sulfopropyl)ammonium hydroxide, imidazole, tryptamine, urea, arginine, povidine, phosphines, triethyl phosphite, phosphonium salts, methyl gallate, ascorbic acid, tannic acid, sodium bisulfite, magnesium hydroxide, calcium sulfate, sodium silicate, thiourea, polysulfides, monensin, nonactin, calixarenes, polymeric epoxides, carbonates, cobalt naphthenate, manganese acetylacetonate and phase transfer catalysts.

35. The method of claim 31, wherein the first polymerization initiator or rate modifier is selected from the group consisting of quaternary ammonium salts and tertiary amines.

36. The method of claim 31, wherein said first polymerization initiator or rate modifier is a tetraalkyl ammonium halide.

37. The method of claim 31, wherein said first polymerization initiator or rate modifier is a tetrabutyl ammonium halide.

38. The method of claim 31, wherein said first polymerization initiator or rate modifier is tetrabutyl ammonium chloride.

39. The method of claim 31, wherein said first polymerization initiator or rate modifier is selected from the group consisting of quaternary ammonium salts.

40. The method of claim 39, wherein said first polymerization initiator or rate modifier is a quaternary ammonium salt represented by one of the following formula: 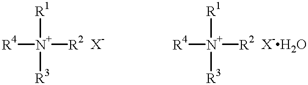
wherein X⁻ is selected from the group consisting of Cl⁻, F⁻, B⁻, I⁻, SO₄⁻, HSO₄⁻, and OH⁻; and R¹, R², R³, and R⁴ are the same or different and are selected from the group consisting of alkyl groups, aryl groups, and aralkyl groups having from 1 to about 20 carbon atoms.

41. The method of claim 31, wherein said first polymerization initiator or rate modifier is an ether amine quaternary compound.

42. The method of claim 41, wherein said ether amine quaternary compound is a compound of formula (I): 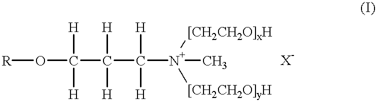
wherein R is a straight or branched alkyl group of from about 2 to about 20 carbon atoms, x and y independently represent an integer of from 1 to about 10, and X is a counterion.

43. The method of claim 42, wherein said counterion is selected from the group consisting of chloride, fluoride, iodide, bromide, sulfate, hydrogen sulfate, sulfite, hydrogen sulfite, bisulfite, carbonate, and bicarbonate.

44. The method of claim 31, wherein said first polymerization initiator or rate modifier is selected from the group consisting of quaternary ammonium sulfates and quaternary ammonium bisulfates.

45. The method of claim 31, wherein said first polymerization initiator or rate modifier is selected from the group consisting of quaternary ammonium hydrogen sulfates and quaternary ammonium hydrogen bisulfates.

46. The method of claim 31, wherein said first polymerization initiator or rate modifier is selected from the group consisting of tetrabutyl ammonium sulfates and tetrabutyl ammonium bisulfates.

47. The method of claim 31, wherein said first polymerization initiator or rate modifier is selected from the group consisting of tetrabutyl ammonium hydrogen sulfate and tetrabutyl ammonium hydrogen bisulfate.

48. The method of claim 31, wherein said first polymerization initiator or rate modifier is selected from the group consisting of tertiary amines.

49. The method of claim 31, wherein said first polymerization initiator or rate modifier is soluble in said liquid adhesive.

50. The method of claim 31, wherein said first polymerization initiator or rate modifier is chemically bonded to a material forming said porous applicator tip.

51. The method of claim 50, wherein said applicator tip comprises a polymerized material.

52. The method of claim 50, wherein said applicator tip comprises a material selected from the group consisting of metal, glass, paper, ceramics, and cardboard.

53. The method of claim 50, wherein said applicator tip comprises a plastics material.

54. The method of claim 50, wherein said applicator tip is at least one of porous, absorbent and adsorbent in nature.

55. The method of claim 50, further comprising loading a second polymerization initiator or rate modifier in or on said applicator tip subsequent to manufacture of said applicator tip, wherein said second polymerization initiator or rate modifier is different from said first polymerization initiator or rate modifier.

56. The method of claim 55, wherein said first and second polymerization initiator or rate modifier each initiates or modifies a rate of polymerization of said liquid adhesive.

57. The method of claim 55, wherein said second polymerization initiator or rate modifier comprises benzalkonium chloride.

58. The method of claim 55, wherein said second polymerization initiator or rate modifier is adsorbed or absorbed on said porous applicator tip.

59. The method of claim 31, wherein said loading step comprises:
mixing said first polymerization initiator or rate modifier with pellets of a polymeric material; and
molding said mixture to form said porous applicator tip.

60. The method of claim 31, wherein said loading step comprises mixing said first polymerization initiator or rate modifier with pellets of a polymeric material while molding said pellets to form said porous applicator tip.

61. The method of claim 31, wherein said loading step comprises:
forming said porous applicator tip in a mold; and
applying said first polymerization initiator or rate modifier to said mold as a release agent, in an amount sufficient for said first polymerization initiator or rate modifier to be loaded in or on said porous applicator tip.

62. The method of claim 31, wherein said loading step comprises:
mixing said first polymerization initiator or rate modifier with foam precursor materials; and
forming a foam from said foam precursor materials to form said porous applicator tip.

63. The method of claim 31, wherein said loading step comprises mixing said first polymerization initiator or rate modifier with a foam material while blowing or expanding said foam material, to form said porous applicator tip.

64. The method of claim 31, wherein said first polymerization initiator or rate modifier is not substantially decomposed during said loading step.

65. An article of manufacture for dispensing a liquid adhesive, said article comprising
an applicator body,
a liquid adhesive contained within said applicator body,
a porous applicator tip attached to said applicator body and in a non-contacting relationship with said liquid adhesive, and
an exchange resin that functions as at least one of a stabilizer or as a polymerization initiator or rate modifier for said liquid adhesive.

66. The article of manufacture of claim 65, wherein said exchange resin is a polymerization initiator or rate modifier for said liquid adhesive.

67. The article of manufacture of claim 65, wherein said exchange resin is a stabilizer for said liquid adhesive.

68. The article of manufacture of claim 65, wherein said exchange resin is in a form of particles or beads.

69. The article of manufacture of claim 65, wherein said exchange resin is mixed with or dispersed in said liquid adhesive.

70. The article of manufacture of claim 65, wherein said exchange resin is located in said applicator body in a non-contacting relationship with said liquid adhesive.

71. The article of manufacture of claim 65, wherein said exchange resin is located in or on said porous applicator tip.

72. An article of manufacture for dispensing a liquid adhesive, said article comprising
an applicator body,
a liquid adhesive and a phase transfer catalyst contained within said applicator body, and
a porous applicator tip attached to said applicator body and through which said liquid adhesive is dispensed.

73. The article of manufacture of claim 72, further comprising a frangible vial held within said applicator body, and wherein said liquid adhesive and phase transfer catalyst are contained within said frangible vial.

74. The article of manufacture of claim 72, wherein said phase transfer catalyst is selected from the group consisting of quaternary ammonium sulfates and quaternary ammonium bisulfates.

75. The article of manufacture of claim 72, wherein said phase transfer catalyst is selected from the group consisting of quaternary ammonium hydrogen sulfates and quaternary ammonium hydrogen bisulfates.

76. The article of manufacture of claim 72, wherein said phase transfer catalyst is selected from the group consisting of tetrabutyl ammonium sulfates and tetrabutyl ammonium bisulfates.

77. The article of manufacture of claim 72, wherein said phase transfer catalyst is selected from the group consisting of tetrabutyl ammonium hydrogen sulfate and tetrabutyl ammonium hydrogen bisulfate.

78. The article of manufacture of claim 72, wherein said liquid adhesive comprises 1,1-disubstituted ethylene monomer.

79. The article of manufacture of claim 72, wherein said liquid adhesive comprises a cyanoacrylate monomer.

80. The article of manufacture of claim 72, wherein said phase transfer catalyst is a direct initiator for said liquid adhesive following a nucleophilic substitution reaction of said phase transfer catalyst and a stronger nucleophilic group.

81. The article of manufacture of claim 72, wherein said nucleophilic substitution reaction replaces a sulfate or bisulfate group in said phase transfer catalyst.

82. The article of manufacture of claim 72, further comprising a polymerization initiator or rate modifier loaded in or on said applicator tip.

83. The article of manufacture of claim 82, wherein said polymerization initiator or rate modifier is different from said phase transfer catalyst.

84. The article of manufacture of claim 82, wherein said polymerization initiator or rate modifier initiates or modifies a rate of polymerization of said liquid adhesive.

85. The article of manufacture of claim 82, wherein said polymerization initiator or rate modifier comprises benzalkonium chloride.

86. The article of manufacture of claim 82, wherein said polymerization initiator or rate modifier is adsorbed or absorbed on said porous applicator tip.

87. a polymerizable monomer adhesive composition, comprising:
a 1,1-disubstituted ethylene monomer;
an anionic stabilizing agent for said 1,1-disubstituted ethylene monomer; and
a phase transfer catalyst.

88. The composition of claim 87, wherein said phase transfer catalyst is selected from the group consisting of quaternary ammonium sulfates and quaternary ammonium bisulfates.

89. The composition of claim 87, wherein said phase transfer catalyst is selected from the group consisting of quaternary ammonium hydrogen sulfates and quaternary ammonium hydrogen bisulfates.

90. The composition of claim 87, wherein said phase transfer catalyst is selected from the group consisting of tetrabutyl ammonium sulfates and tetrabutyl ammonium bisulfates.

91. The composition of claim 87, wherein said phase transfer catalyst is selected from the group consisting of tetrabutyl ammonium hydrogen sulfate and tetrabutyl ammonium hydrogen bisulfate.

92. The composition of claim 87, wherein said liquid adhesive comprises a cyanoacrylate monomer.

93. The composition of claim 87, wherein said phase transfer catalyst is a direct initiator for said liquid adhesive following a nucleophilic substitution reaction of said phase transfer catalyst and a stronger nucleophilic group.

94. The composition of claim 87, wherein said nucleophilic substitution reaction replaces a sulfate or bisulfate group in said phase transfer catalyst.

95. The composition of claim 87, wherein said phase transfer catalyst also acts as a stabilizer for said 1,1-disubstituted ethylene monomer.
